(19) United States
(12) Patent Application Publication
(10) Pub. No.: US 2017/0344883 A1
(43) Pub. Date: Nov. 30, 2017

(54) SYSTEMS AND METHODS FOR CONTROL, ANALYSIS, AND/OR EVALUATION OF DYNAMICAL SYSTEMS

(71) Applicants: Yeda Research and Development Co. Ltd., Rehovot (IL); Technion Research & Development Foundation Limited, Haifa (IL)

(72) Inventors: Yoav SOEN, Rehovot (IL); Hallel SCHREIER, Clil (IL); Naama BRENNER, Haifa (IL)

(21) Appl. No.: 15/607,695

(22) Filed: May 30, 2017

Related U.S. Application Data
(60) Provisional application No. 62/343,167, filed on May 31, 2016.

(51) Int. Cl. G06N 3/08; G06N 3/04

(52) U.S. Cl. CPC G06N 3/08; G06N 3/04

(57) ABSTRACT

There is provided a method comprising: receiving a graph comprising nodes with directional edges each associated with a variable weight representing an interaction strength of the respective direction edge adjustable according to a respective range; calculating a current global value defined by a function of the variable weights of the directional edges; calculating a mismatch between the current global value and a desired global value, wherein multiple different combinations of assigned variable weights of the directional edges are associated with the desired global value within the tolerance requirement; determining when the mismatch is within a tolerance requirement representing desired global values; and one of: randomly adjusting the variable weights of the directional edges within the respective range, and iterating the calculating the mismatch and determining when the mismatch is not within the tolerance requirement, and outputting determined values for the variable weights when the mismatch is within the tolerance requirement.

### RELATED APPLICATION

This application claims the benefit of priority under 35 USC 119(e) of U.S. Provisional Patent Application No. 62/343,167 filed on May 31, 2016, the contents of which are incorporated herein by reference in their entirety.

### FIELD AND BACKGROUND OF THE INVENTION

The present invention, in some embodiments thereof, relates to dynamical systems and, more specifically, but not exclusively, to systems and/or methods for control, analysis, and/or evaluation of dynamical systems.

Dynamical systems may include, for example, chaotic systems. Such systems include unstable, periodic orbits. Chaotic systems may be controlled by adjustments to the system that stabilize the system, to make the system more predictable. An example of a method to control chaotic systems includes the OGY (Ott, Grebogi, and Yorke) method.

### SUMMARY OF THE INVENTION

According to an aspect of some embodiments of the present invention there is provided a computer implemented method for identifying values for variable weight parameters of edges of a network according to a desired global value within a tolerance requirement, comprising: receiving a graph representation of a network comprising nodes with directional edges each associated with a variable weight representing an interaction strength of the respective direction edge adjustable according to a respective range; calculating a current global value defined by a function of the variable weights of the directional edges; calculating a mismatch between the current global value and a desired global value, wherein multiple different combinations of assigned variable weights of the directional edges are associated with the desired global value within the tolerance requirement; determining when the mismatch is within a tolerance requirement representing desired global values; and one of: randomly adjusting the variable weights of the directional edges within the respective range, and iterating the calculating the mismatch and determining when the mismatch is not within the tolerance requirement, and outputting determined values for the variable weights of the directional edges when the mismatch is within the tolerance requirement.

Optionally, randomly adjusting comprises randomly adjusting the variable weights of the directional edges within the respective range according to a function proportional to the amount of mismatch.

Optionally, an iterative reduction in the amount of mismatch reduces the amount of the random adjustment within the respective range.

Optionally, the network represents a chemical reaction, wherein each node represents a reactant, or an intermediate product, wherein each directed edge represents a reaction condition, wherein the desired global value represents a desired product, wherein the tolerance requirement represents a tolerance of the desired product.

Optionally, the network represents a gene regulatory network, wherein each directed edge represents the effect of one gene product on another gene through various mechanisms of regulation, wherein the desired global value represents a phenotype, the mismatch from the desired global value represents a global cellular stress signal, wherein the tolerance requirement represents a range of phenotypes compatible with a constraining demand.

Optionally, an initial set of the variable weights assigned to the directional edges are randomly determined within the respective range.

Optionally, the method further comprises receiving an initial topological structure of the network, and converting the initial topological structure to an adapted topological structure of the graph including at least a scale-free out-degree distribution, wherein the initial topological structure and the adapted topological structure are statistically similar according to a graph similarity requirement.

Optionally, the in-degree distribution of the adapted topological structure of the graph is a member of the group consisting of: scale-free distribution, exponential distribution, and binomial distribution. Optionally, converting comprises performing a graph transformation.

Optionally, the method further comprises analyzing the topological structure of the graph representation of the network, and applying the acts of the computer implemented method when the topological structure is identified at least as including a scale-free out-degree distribution.

Optionally, the method further comprises receiving an initial graph state of the network, analyzing the graph to identify a set of largest nodes with the largest number of edges, and transforming the initial graph state of the network to an adapted graph state of the network having an adapted set of the largest nodes with a reduced number of the largest number of edges.

Optionally, the number of nodes is at least 1000.

Optionally, the current global value is calculated by a linear or non-linear combination of the variable weights of the directional edges.

Optionally, the current global value is calculated as a linear or non-linear combination of coordinates corresponding to the variable weight parameters.

Optionally, the graph represents a dynamical system represented by at least one function that describes time dependence motion of at least one point in a geometrical space.

Optionally, the mismatch is calculated by a step function outside the tolerance requirement and a value of zero within the tolerance requirement.

Optionally, the determined values are outputted when at least one combination of variable weight parameters that give rise to at least one set of coordinates or which the global value falls stably within the tolerance requirement of the desired global value.

According to an aspect of some embodiments of the present invention there is provided a system for identifying values for variable weight parameters of edges of a network according to a desired global value within a tolerance requirement, comprising: a program store storing code; and a processor coupled to the program store for implementing the stored code, the code comprising: code to receive a graph representation of a network comprising nodes with directional edges each associated with a variable weight representing an interaction strength of the respective direction edge adjustable according to a respective range; code to calculate a current global value defined by a function of the variable weights of the directional edges, calculate a mismatch between the current global value and a desired global value, wherein multiple different combinations of assigned variable weights of the directional edges are associated with the desired global value within the tolerance requirement, and determine when the mismatch is within a tolerance requirement representing desired global values; and one of: randomly adjust the variable weights of the directional edges within the respective range, and iterating the calculating the mismatch and determining when the mismatch is not within the tolerance requirement, and output determined values for the variable weights of the directional edges when the mismatch is within the tolerance requirement.

According to an aspect of some embodiments of the present invention there is provided a computer program product comprising a non-transitory computer readable storage medium storing program code thereon for implementation by a processor of a system for identifying values for variable weight parameters of edges of a network according to a desired global value within a tolerance requirement, comprising: instructions to receive a graph representation of a network comprising nodes with directional edges each associated with a variable weight representing an interaction strength of the respective direction edge adjustable according to a respective range; instructions to calculate a current global value defined by a function of the variable weights of the directional edges; instructions to calculate a mismatch between the current global value and a desired global value, wherein multiple different combinations of assigned variable weights of the directional edges are associated with the desired global value within the tolerance requirement; instructions to determine when the mismatch is within a tolerance requirement representing desired global values; and instructions to perform one of: randomly adjust the variable weights of the directional edges within the respective range, and iterating the calculating the mismatch and determining when the mismatch is not within the tolerance requirement, and output determined values for the variable weights of the directional edges when the mismatch is within the tolerance requirement.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for identifying values for variable weight parameters of edges of a graph, in accordance with some embodiments of the present invention;

FIG. 2 is a block diagram of a system that automatically identifies values for the variable weight parameters according to a desired global value within a tolerance requirement, in accordance with some embodiments of the present invention;

FIG. 3 includes exemplary charts to help understand the process of identifying values for variable weight parameters of edges of a network according to a desired global value within a tolerance requirement, in accordance with some embodiments of the present invention;

FIG. 4 includes charts depicting factors that may (or may not) affect the speed of convergence, and/or whether convergence occurs at all, in accordance with some embodiments of the present invention;

FIG. 5 includes charts that evaluate the contribution of outgoing hubs to convergence, in accordance with some embodiments of the present invention;

FIG. 6 includes charts of computed results of convergence time, in accordance with some embodiments of the present invention; and

FIG. 7 includes charts depicting computed results designed to test whether network topology has an intrinsic influence on the ability to support convergent dynamics independently of constraints, in accordance with some embodiments of the present invention.

### DESCRIPTION OF SPECIFIC EMBODIMENTS OF THE INVENTION

The present invention, in some embodiments thereof, relates to dynamical systems and, more specifically, but not exclusively, to systems and/or methods for control, analysis, and/or evaluation of dynamical systems.

An aspect of some embodiments of the present invention relates to systems and/or methods (e.g., stored value identification code instructions executable by processor(s)) that identify values for variable weight parameter(s) of edges of a graph according to a desired global value, e.g. a combination of coordinates (e.g., linear, and/or non-linear combination), in a dynamical system defined on that graph, within a tolerance requirement of the desired global value. The desired global value within the tolerance requirement may be obtained by multiple combinations of the coordinates and/or by multiple combinations of variable weight parameters. The value(s) are identified by a small random (and/or non-deterministic and/or stochastic) adjustment of one or more variable weight parameters of the edges of the graph (e.g., small may be determined according to the context of the edges of the graph, for example, a percentage or absolute value or other function considered small in context). When a mismatch (i.e., within the tolerance requirement) is calculated between the desired global value and a current global value (e.g., calculated by a function, for instance a step function outside the tolerance requirement. The step function may be defined as zero within the tolerance requirement.), the assigned variable weight parameters are randomly adjusted within respective predefined ranges. The mismatch and the random generation of generated variable weight parameters are iterated until the current global value falls within the tolerance requirement of the desired global value. It is sufficient for the value identification code to identify one suitable combination of variable weight parameters that gives rise to one set of coordinates for which the global value falls stably within the tolerance requirement of the desired global value.

Additional suitable combinations do not necessarily need to be identified, since multiple suitable combinations of variable weight parameters achieve the same result of the desired global value within the tolerance requirement. For example, when the graph represents chemical reaction of reactants to obtain a desired product (within the tolerance requirement), one combination of suitable chemical reactants and/or reaction conditions may be found. Additional combinations are not necessarily required when the other combinations achieve a similar product (i.e., the desired product within the tolerance requirement).

Optionally the adjustment of various of respective variable weight parameters (during the next iteration) is performed by adding an independent random variable to each respective edge. Alternatively or additionally, the adjustment of values of respective variable weight parameters (during the next iteration) is performed relative to the current assigned values. For example, the adjustment may be a random value as a function of the current assigned value.

Optionally, the adjustment of the values of respective variable weight parameters is performed in proportion to the amount of calculated mismatch. When the mismatch amount is relatively high, which may suggest that the assigned variable weight parameter values are relatively far from providing the desired global value, the random adjustment is performed within a wider range, and/or with relatively larger values. The larger random adjustment may represents larger steps (which may require fewer steps) to arrive at the designed global value. When the mismatch amount is relatively low, which may suggest that the assigned variable weight parameters are relatively close to providing the desired global value, the random adjustment is performed within a relatively narrow range, and/or within relatively smaller values. The smaller random adjustment may represent finer steps to arrive at the desired global value. The smaller adjustments may prevent selection of variable weight parameters that result in a larger mismatch amount.

Optionally, the graph is a directional graph with directional edges. Each directional edge is associated with a respective variable weight parameter.

The edges of the graph may be predefined, remaining unchanged during the mismatch calculation and random generation iteration process. The variable weight parameter may represent the interaction strength of the respective edges (e.g., directional edge), which are adjusted during the mismatch calculation and random generation iteration process.

Optionally, the graph is selected for processing by the value identification code. Optionally, the selected graph includes at least a scale-free distribution, optionally a scale-free out-degree distribution. Alternatively or additionally, the topological structure of the graph is converted into the scale-free distribution, optionally the scale-free out-degree distribution, for example, by graph transposition methods. The adapted graph (with scale-free distribution) may be statistically similar to the initial topological structured graph (i.e., without scale-free distribution) according to a graph similarity requirement. Inventors discovered that probability of identifying a set of variable parameter weights that achieve the desired global value (within the tolerance requirement) is relatively high and the time for convergence relatively fast for graphs with scale-free out-degree distributions.

Optionally, the initial graph is processed to identify a set of nodes (also referred to herein as hubs) with the largest number of edges. The initial graph may be adapted (e.g., using graph transposition methods) to reduce the number of edges of the largest nodes of the identified set, for example, by deleting nodes and edges. Inventors discovered that probability of identifying a set of variable parameter weights that achieve the desired global value (within the tolerance requirement) is relatively low for graphs with a reduced number of hubs.

Optionally, the graph includes a large number of nodes and/or large number of edges, optionally at least 1000 nodes.

Optionally, the initial values of the variable weight parameters are unknown, and/or are randomly selected.

The systems and/or methods (e.g., stored code executed by processor(s)) described herein relate to the technical problem of identifying multiple variable weight parameters to achieve a desired objective defined on the coordinates of the dynamical system associated with the graph (optionally, a single desired outcome defined by the desired global value according to the tolerance requirement). The technical problem is to be solved within a reasonable time frame, using reasonable computing devices. It is noted that the technical problem may fall into the context of control of chaotic systems, rather than, for example, multi-objective optimization systems which include multiple objectives that are simultaneously optimized.

The systems and/or methods (e.g., stored code executed by processor(s)) described herein improve performance of a computing device and/or computing system (e.g., client terminal and/or server), by reducing the time and/or processing hardware (e.g., memory, processor(s), providing computational efficiency improvements) to identify values for the variable weight parameter(s) to achieve the desired global value within the tolerance requirement. The systems and/or methods (e.g., stored code executed by processor(s)) identify the values for the variable weight parameter(s) by iteratively assigning random (and/or non-deterministic) values to the variable weight parameter(s), and evaluating the mismatch amount, which may be performed with relatively fewer processing resources and/or in a relatively shorter amount of time, for example, relative to other methods that solve complex equations. It is noted that the systems and/or methods (e.g., stored code executed by processor(s)) do not necessarily solve equations (in comparison to other methods that solve equations of an optimization problem), rather, the iteration represents a trial and error method that attempts to arrive within a suitable solution space (represented by the desired global value according to the tolerance requirement). For example, the iterations arrive at a set of values for the variable weight parameters without necessarily requiring prior information (e.g., orbits of a chaotic system), in comparison to other methods (e.g., OGY, E. Ott, C. Grebori, and J. A. Yorke) that requires prior information about the orbits of the system (e.g., Poincare section).

The systems and/or methods described herein may process a graph and/or network with a relatively large number of nodes (e.g., over about 1000, or over about 3000, or other values) to arrive at an arbitrary solution from a set of many possible solutions, quickly, and/or using a relatively few computing resources.

The systems and/or methods may identify one or more sets of values (which may be arbitrary values) for the variable weight parameters that arrive at one or more solutions within the solution space (according to the tolerance requirement) from the set of available combinations of possible values (which may be extremely large or event infinite) in a reasonable amount of time and/or using a reasonable amount of computing resources.

The systems and/or methods described herein may allow for real-time control of the dynamics of chaotic and/or complex systems, by selection of values for the variable weight parameters in real-time using commonly available computing resources.

Accordingly, the systems and/or methods described herein are inextricably tied to computer technology, to overcome an actual technical problem arising in large complex systems in which a common goal (defined within a solution space of multiple suitable solutions) may be arrived at by multiple combinations of variables.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term convergence (e.g., of the graph and/or network) refers to identification of values for the variable weight parameters that arrive at a stable fixed point and/or other confined state of the system with the desired global value within the tolerance requirement, for example, including a small amplitude limit cycle that leaves the global variable inside the tolerance requirement.

As used herein, the terms random, non-deterministic, and stochastic are interchangeable.

As used herein, the term variable weight parameter may sometimes be interchanged, and/or may sometimes include the term coordinates, for example, according to the implementation of the graph and/or network. For example, systems represents by graphs (i.e., nodes connected by edges) may include variable weight parameters associated with the edges. Systems represented by function(s) that describe motion (e.g., time dependence) of point(s) in a space (e.g., geometrical space) may include coordinates. It is understood that where graph and variable weight parameters are discussed, the discussion may be applicable to dynamical system and coordinates. Similarly, it is understood that where dynamical system and coordinates are discussed, the discussion may be applicable to graph and variable weight parameters.

As used herein, the terms network and graph are meant to include other representation of complex systems, for example, dynamical systems which may be represented by function(s) that describe motion (e.g., time dependence) of point(s) in a space (e.g., geometrical space).

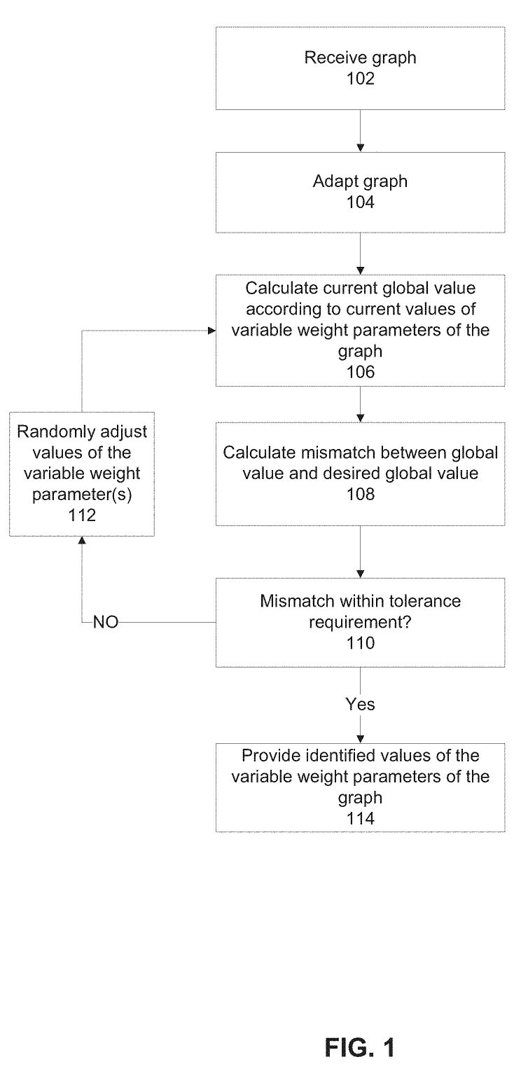

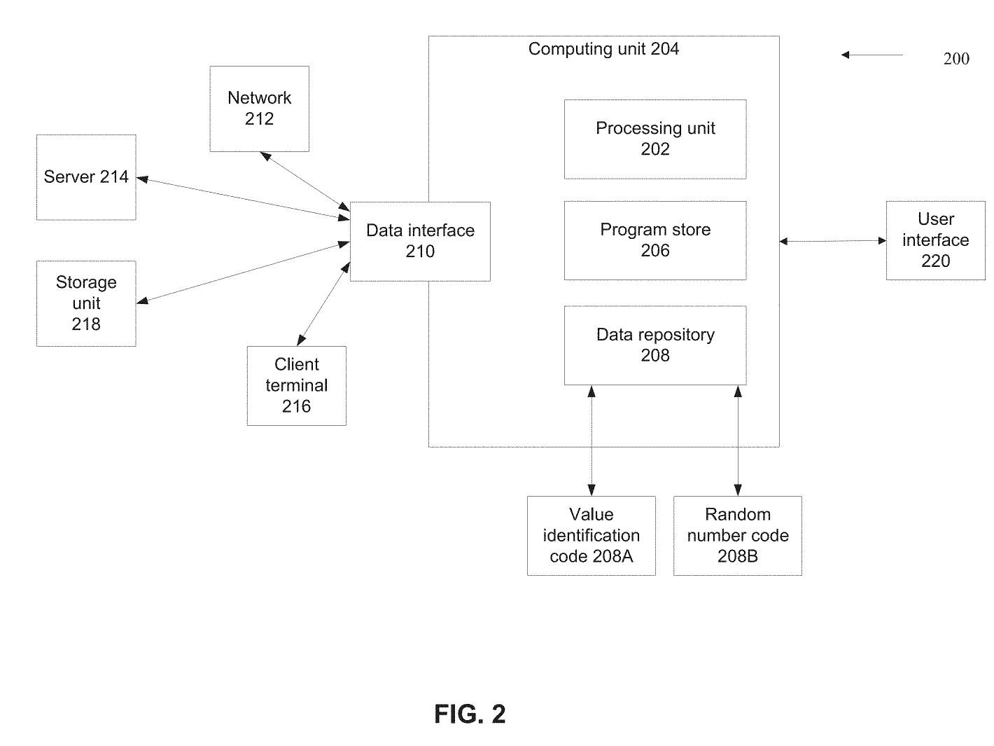

Reference is now made to FIG. 1, which is a flowchart of a method for identifying values for variable weight parameters of edges of a graph, in accordance with some embodiments of the present invention. Reference is also made to FIG. 2, which is a block diagram of a system 200 that automatically identifies values for the variable weight parameters according to a desired global value within a tolerance requirement (e.g., linear and/or non-linear combination of coordinates), in accordance with some embodiments of the present invention. System 200 may execute the acts of the method described with reference to FIG. 1, for example, by a processing unit 202 of a computing unit 204 executing code instructions stored in a program store 206.

The systems and/or methods (e.g., stored code executed to processor(s)) provide a model of exploratory adaptation driven by failure to satisfy a global constraint (referred to herein as the desired global value according to the tolerance requirement) and relaxing by a random search (optionally a purely random search) in the high dimensional space of network (e.g., graph) connections (e.g., edges). As described herein in additional detail, inventors discovered that such convergence depends on a network topology that includes a broad distribution of outgoing degrees in the network, while the heterogeneity of incoming degrees is far less important for adaptation. The result is an unexpected discovered, since such difference between outgoing and incoming degrees cannot be explained by the eigenvalues of the interaction matrix, or any other property that is invariant under transposition. Convergence of exploratory adaptation appears to be a complex process characterized by an extremely broad distribution of times. Inventors hypothesize that the convergence likely depends on a delicate interplay between the phase space structure of the different network ensembles, their connectivity properties in the space of networks (see for example, A. Wagner, “The Origins of Evolutionary Innovations: A Theory of Transformative Change in Living Systems”, Oxford University Press (2011)), and/or the typical timescales of their intrinsic dynamics.

It is noted that the systems and/or methods described herein are different than neural network models (see for example, W. Maass, T. Natschlger and H. Markram, “Real-time computing without stable states: A new framework for neural computation based on perturbations.” Neural computation 14, 2531-2560 (2002). And/or D. Sussillo and L. F. Abbott. “Generating coherent patterns of activity from chaotic neural networks.” Neuron 63, 544-557 (2009). And/or O. Barak, et al. “From fixed points to chaos: three models of delayed discrimination.” Prog. Neurobiol. 103, 214-222 (2013)) in relying on (e.g., purely) stochastic (e.g., random and/or non-deterministic) exploratory dynamics. In the language of learning theory, the task is modest: convergence to a fixed point (or a small amplitude trajectory) which satisfies a low-dimensional approximate constraint. Without the systems and/or methods described herein, this task could be fulfilled with a very small probability. The probability of convergence increases dramatically using exploratory dynamics with networks capable of supporting convergence, as described herein in additional detail. The ability to achieve high success rates of convergence without a need for complex computation or fine-tuning, makes this adaptation particularly plausible for biological implementation, and/or implementation using fewer and/or simpler processing resources and/or may be performed in a shorter time using available processing resources.

It is further noted, that other previous theoretical work has used random-network models to address evolutionary dynamics of gene regulation over many generations. However, these methods are different than the systems and/or methods described herein, since such methods are based on a population of networks undergoing mutations and reproducing according to an assigned fitness (see for example, A. Bergman and M. L. Siegal, “Evolutionary capacitance as a general feature of complex gene networks.” Nature 424, 549-552 (2003), and/or P. Oikonomou and P. Cluzel, “Effects of topology on network evolution.” Nature Physics 2, 532-536 (2006)). Such methods differ, for example, in timescales, level of organization, and biological phenomena, from the systems and/or methods described herein. For example, significant differences are observed in evolutionary dynamics between homogeneous and scale-free networks (see for example, P. Oikonomou and P. Cluzel, “Effects of topology on network evolution.” Nature Physics 2, 532-536 (2006)). In another example, gene regulatory networks display multi-faceted behavior depending on the type of environment they encounter and the timescales of observation. Pre-evolved responses, exploratory adaptation and population-level evolution are different aspects of such system (see for example, L. Lopez-Maury, S. Marguerat and J. Bahler, “Tuning gene expression to changing environments: from rapid responses to evolutionary adaptation”. Nat. Rev. Genet. 9, 583-93 (2008)), which may be integrated into a more general picture where the response depends on the type of challenge and contains dynamics on multiple timescales (see for example, A. H. Yona, I. Frumkin and Y. Pilpel, “A relay race on the evolutionary adaptation spectrum”, Cell 163, 549 (2015)), which may be evaluated and/or controlled by the systems and/or methods described herein.

The systems and/or methods described herein may be used to model adaptation of cells and/or higher level organisms, which may be used to control, predict, and/or evaluation the adaptation, for example, in response to an externally applied stress. Cells and organisms cope with common types of stress using pre-evolved adaptations, but also have some ability to withstand novel challenges (see for example, E. Braun, “The unforeseen challenge: from genotype-to-phenotype in cell populations”. Rep. Prog. Phys. 78, 036602 (2015), and/or Y. Soen, M. Knafo and M. Elgart, “A principle of organization which facilitates broad Lamarckian-like adaptations by improvisation”. Biology Direct 10, 68 (2015)). Gene regulation plays important roles in both types of responses. While much has been learnt about pre-evolved and reproducible adaptive responses, the principles and mechanisms of regulatory adaptation to unforeseen challenges are poorly understood. The systems and/or methods described herein may be used to address this aspect of gene regulation, using the described random network model (e.g., stored code executable by processor(s)) demonstrating capacity to adapt by (optionally purely) exploratory dynamics. As discussed herein in additional detail, exploration is induced by failure to satisfy a global constraint (also referred to herein as desired global value according to tolerance requirement) and ceases when the constraint is stably satisfied. As discussed herein, inventors discovered that successful convergence of exploratory dynamics depends on network topology, and is most efficient for scale-free connectivity, which allows the systems and/or methods described herein to be used for gene regulatory networks represented using the scale-free topology.

Inventors discovered that convergence of networks with scale-free topology is typically achieved without fine tuning of initial conditions and/or model parameters. Inventors discovered a connection between cellular adaptation to unforeseen challenges and learning in neural systems.

Computing unit 204 may be implemented as, for example, a client terminal, a server, a computing cloud, a mobile device, a desktop computer, a thin client, a Smartphone, a Tablet computer, a laptop computer, a wearable computer, glasses computer, and a watch computer. Computing unit 204 may include locally stored software that performs one or more of the acts described with reference to FIG. 1, and/or may act as one or more servers (e.g., network server, web server, a computing cloud) that provides services (e.g., one or more of the acts described with reference to FIG. 1) to one or more client terminals, for example, providing software as a service (SaaS) to the client terminal(s), providing an application for local download to the client terminal(s), and/or providing functions using a remote access session to the client terminals, such as through a web browser.

Processing unit 202 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processing unit(s) 202 may include one or more processors (homogenous or heterogeneous), which may be arranged for parallel processing, as clusters and/or as one or more multi core processing units.

Program store 206 stores code instructions implementable by processing unit 206, for example, a random access memory (RAM), read-only memory (ROM), and/or a storage device, for example, non-volatile memory, magnetic media, semiconductor memory devices, hard drive, removable storage, and optical media (e.g., DVD, CD-ROM).

Computing unit 204 may include a data repository 208 for storing data, for example, value identification code 208A (that performs one or more acts of the methods described with reference to FIG. 1), and/or random number code 208B (that obtains and/or generates random values for adjustment of the weight parameters, as described herein). Data repository 208 may be implemented as, for example, a memory, a local hard-drive, a removable storage unit, an optical disk, a storage device, and/or as a remote server and/or computing cloud (e.g., accessed using a network connection).

Computing unit 204 may include a data interface 210, for example, one or more of, a network interface card, a universal serial bus (USB) connector, a wireless interface to connect to a wireless network and/or storage device, a physical interface for connecting to a cable for network connectivity, a virtual interface implemented in software, network communication software providing higher layers of network connectivity, and/or other implementations.

Computing unit 204 may connect using data interface 210 and/or network 212 (and/or another communication channel, such as through a direct link (e.g., cable, wireless) and/or indirect link (e.g., via an intermediary computing unit such as a server, and/or via a storage device) with one or more of: a server(s) 214, client terminal 216 (e.g., when computing unit 204 acts as a server, for example, provided SaaS), and a storage unit 218 (e.g., a storage server, a computing cloud storage server).

Computing unit 204 includes or is in communication with a user interface 220 allowing a user to enter data and/or view presented data. Exemplary user interfaces 220 include, for example, one or more of, a touchscreen, a display, a keyboard, a mouse, and voice activated software using speakers and microphone.

Referring now back to FIG. 1, at 102, a network representation is received by computing unit 204. The network representation may be received, for example, by a user manually entering the network representation using user interface 220, accessing a stored network representation (e.g., stored in data repository 208), transmitted by client terminal 216, and/or received from a remote location and/or external storage device (e.g., stored on server 214, and/or storage unit 218).

Optionally, a graph represents the network. Alternatively or additionally, a graph representation is created based on the network representation, for example, by code that analyzes and/or parses the network representation and builds the graph.

The network and/or graph may be stored and/or represented, for example, using a set-of-rules, database entries with links, software code, code written in a domain specific language to represent graphs, an image, and/or other methods.

As used herein, the term graph may sometimes be interchanged with the word network.

As used herein, the term edge sometimes means directional edge (i.e., when the graph includes directional edges).

The graph representation of the network includes multiple nodes, each having one or more edges, optionally directional edges. Each edge (optionally directional edge) is associated with one or more variable weight parameters (and/or coordinates) representing interaction strengths (also referred to herein as variable weight parameters) of the respective edge (optionally directional edge). Each variable weight parameter of each edge is associated with a range defining allowable values of the variable weight parameters. The variable weight parameters may be, for example, normalized values (e.g., on a range of 0 to 1), absolute values (e.g., real numbers, integers), and/or functions (e.g., evaluated dynamically). The ranges may be, for example, absolute and/or fixed value ranges, a function of the current value, and/or other functions (e.g., evaluated dynamically).

Optionally, the graph represents a dynamical system represented by function(s) that describes motion (e.g., time dependence) of point(s) in a space (e.g., geometrical space).

The graph and/or network representation includes components, mathematically) represented as \vec{x}=(x₁, x₂ . . . x_{N}). Each component may be represented, for example, by a node of the graph. The number of nodes may be larger, for example, at least 500, at least 1000, or at least 1500, or at least 3000, or at least 5000, or other values.

Optionally, the components may be associated with coordinates and/or weight parameters, for example, defined by non-linear equations of motion mathematically represented as:

\vec{x}=Wφ(\vec{x})−\vec{x}

Where:

W denotes a random interaction matrix,

φ(\vec{x}) denotes a saturation function restricting the variable's dynamic range, and relaxation rates may be normalized to unity.

Alternatively or additionally, other equations may be used according to the representation of the graph, for example, equations describing memory and/or learning in neuronal networks (see for example, D. J. Amit, “Modeling brain function: The world of attractor neural networks”. Cambridge University Press; (1992)), and evolutionary dynamics of gene regulatory networks (see for example, S. A. Kauffman, “Origins of Order: Self-Organization and Selection in Evolution”, Oxford University Press (1993) and/or A. Wagner, “The Origins of Evolutionary Innovations: A Theory of Transformative Change in Living Systems”, Oxford University Press (2011)).

Optionally, an ensemble of random matrices W is used, represented by an element-wise (Hadamard) product represented mathematically as:

W=T∘J.

Where:

T denotes a topological backbone matrix (e.g., adjacency matrix) with binary (i.e., 0 or 1) entry values representing a potential for interaction between network elements (e.g., edges, optionally directional edges, between nodes). T may be predefined, and unaltered during processing (e.g., at block 106 and above). It is noted that T may be adapted during a pre-processing phase, for example, when the graph is optionally transformed and/or adapted, as described with reference to block 104.

J denotes a matrix denoting the actual interaction strengths, optionally including randomly generated values, and/or values obtained using other non-deterministic methods. The values of J may be adapted, for example, as described herein.

The network may represent a gene regulatory network. The ability to organize a large number of interacting processes into persistently viable states in a dynamic environment is a striking property of cells and organisms. Frequently encountered environmental and internal perturbations trigger adaptive responses that were assimilated into the system during evolution. Such responses involving characteristic induction of certain mechanisms (see for example, A. P. Gasch P. T. Spellman C. M. Kao, O. Carmel-Harel M. B. Eisen G. Storz, D. Botstein and P. O. Brown, “Genomic expression programs in the response of yeast cells to environmental changes”. Mol Biol Cell, 1142414257 (2000) and/or H. C. Causton, et al. “Remodeling of Yeast Genome Expression in Response to Environmental Changes.” Mol. Biol. Cell, 323-33712 (2001) and/or L. Lopez-Maury, S. Marguerat and J. Bahler, “Tuning gene expression to changing environments: from rapid responses to evolutionary adaptation”. Nat. Rev. Genet. 9, 583-93 (2008)) may be represented by the graph described herein, and/or may be controlled and/or evaluated by the systems and/or methods (e.g., code executable by processor(s)). For example, the underlying molecular pathways and gene regulatory networks (see for example, C. T. Harbison et al., “Transcriptional regulatory code of a eukaryotic genome” Nature 431, 99(2004) and/or C. Boone, H. Bussey and B. J. Andrews. “Exploring genetic interactions and networks with yeast.” Nature Reviews Genetics 8, 437-449 (2007)) may be represented by the graph described herein and/or evaluated and/or controlled by the systems and/or methods described herein. The systems and/or methods described herein may analyze and/or control the effects of non-deterministic processes on gene regulation (see for example, K. J. Niklas, S. E. Bondos, A. K. Dunker and S. A. Newman, “Rethinking gene regulatory networks in light of alternative splicing, intrinsically disordered protein domains, and post-translational modifications”. Front. Cell Dev. Biol. 3, (2015)), for example, to predict and/or control the response of cells to unforeseen challenges before the cells have had a chance to evolve efficient adaptive mechanisms through mutation and selection (see for example, E. Braun, “The unforeseen challenge: from genotype-to-phenotype in cell populations”. Rep. Prog. Phys. 78, 036602 (2015) and/or Y. Soen, M. Knafo and M. Elgart, “A principle of organization which facilitates broad Lamarckian-like adaptations by improvisation”. Biology Direct 10, 68 (2015)).

Inventors realized that although the capacity to withstand unforeseen conditions has been demonstrated and studied using dedicated experimental models of novel challenge in yeast (see for example S. Stern, T. Dror, E. Stolovicki, N. Brenner and E. Braun, “Genome-wide transcriptional plasticity underlies cellular adaptation to novel challenge”, Mol. Sys. Biol. 3, article 106 (2007) and/or Y. Katzir, E. Stolovicki, S. Shay and E. Braun. “Cellular plasticity enables adaptation to unforeseen cellcycle rewiring challenges.” PloS one 7, e45184 (2012)) and flies (see for example, S. Stern, Y. Fridmann-Sirkis, E. Braun and Y. Soen. “Epigenetically heritable alteration of fly development in response to toxic challenge.” Cell reports 1, no. 5 (2012): 528-542), it remains unknown whether and how such exploratory dynamics could converge to new stable states. The systems and/or methods described herein allow prediction and/or control of the new stable states according to the unforeseen conditions. The responses exposed in the experiments referred to above exhibited increased gene expression variability followed by convergence to altered patterns of expression. Analysis of repeated experiments further showed that a large fraction of the transcriptional response can vary substantially across replicated trajectories of adaptation (see for example, S. Stern, T. Dror, E. Stolovicki, N. Brenner and E. Braun, “Genome-wide transcriptional plasticity underlies cellular adaptation to novel challenge”, Mol. Sys. Biol. 3, article 106 (2007)). These findings suggest that the ability to adapt to unforeseen challenges within one or a few generations is supported by exploratory processes that are induced by stress (see for example, E. Braun, “The unforeseen challenge: from genotype-to-phenotype in cell populations”. Rep. Prog. Phys. 78, 036602 (2015) and/or Y. Soen, M. Knafo and M. Elgart, “A principle of organization which facilitates broad Lamarckian-like adaptations by improvisation”. Biology Direct 10, 68 (2015)). It has also been hypothesized that adaptation is achieved by reduction of drive for further changes (see for example, Y. Soen, M. Knafo and M. Elgart, “A principle of organization which facilitates broad Lamarckian-like adaptations by improvisation”. Biology Direct 10, 68 (2015)). The systems and/or methods described herein may be used to control and/or predict the adaption of cells and/or other organisms (e.g., yeast, flies).

The graph described herein may be used to represent gene regulatory networks that may support adaptations as described in the above paragraph. For example, the graph may include a large number of potential interactions between genes (see for example, A. H. Y. Tong, G. Lesage, G. D. Bader, H. Ding, H. Xu, X. Xin, J. Young et al. “Global mapping of the yeast genetic interaction network.” Science 303, 808-813 (2004)), context-dependent plasticity of interactions (see for example, C. T. Harbison et al., “Transcriptional regulatory code of a eukaryotic genome” Nature 431, 99(2004) and/or N. M. Luscombe, et al. “Genomic analysis of regulatory network dynamics reveals large topological changes.” Nature 431 308-312 (2004) and/or K. J. Niklas, S. E. Bondos, A. K. Dunker and S. A. Newman, “Rethinking gene regulatory networks in light of alternative splicing, intrinsically disordered protein domains, and post-translational modifications”. Front. Cell Dev. Biol. 3, (2015)), and multiplicity of microscopic configurations consistent with a given phenotype (see for example, K. M. Weiss and S. M. Fullerton, “Phenogenetic drift and the evolution of genotypephenotype relationships”. Theoret. Pop. Biol. 31, 187-95 (2000)). The graph may represent a network model that demonstrates the feasibility of coping with unforeseen challenges by exploratory dynamics, which may allow prediction and/or control of the genetic network. Each component of the graph (as described herein) may represent the intracellular dynamical variables in the gene regulatory network. The network may represent a gene regulatory network, where each directed edge represents the effect of one gene product on another gene through various mechanisms of regulation. The desired global value represents a phenotype. The deviation (i.e., mismatch) from the desired global value represents a global cellular stress signal, where the tolerance requirement represents a range of phenotypes compatible with the constraining demand.

The graph described herein may be used to represent a chemical reaction, where each node represents a reactant, or an intermediate product. Each directed edge represents a reaction condition (e.g., temperature, pressure, amount of reactant). The desired global value represents a desired product. The tolerance requirement represents a tolerance of the desired product, for example, allowable amount of impurities, isomer variations, and range of the amount of the desired product.

Optionally, at 104, the received graph is adapted, for example, by graph adaptation and/or transformation code, which may be stored in data repository 208 of computing unit 204 executable by processing unit 202.

The graph may be adapted to improve the efficiency of computing unit 204 in identifying the set of values for the weight parameters that satisfy the desired global value within the tolerance requirement.

Optionally, an initial set of the variable weights assigned to the (optionally) directional edges and/or coordinates is randomly determined, according to respective ranges. The randomly determined initial set of values may be obtained and/or generated when the initial set of values is unknown. Inventors discovered that convergence of the graph is achievable (i.e., within a reasonable time and/or using reasonable computing resources) when using the randomly determined initial set of values.

Optionally, an initial topological structure of the network is received and converted to an adapted topological structure including at least a scale-free distribution, optionally an out-degree scale-free distribution. The in-degree distribution of the initial topological structure may be adapted, for example, to a scale-free distribution, exponential distribution, binomial distribution, or other. As discussed herein, inventors discovered that graphs including out-degree scale-free distributions converge more efficiently than graphs having other distributions, for example, in terms of relatively faster processing, have a higher probability of convergence, and/or using fewer computational resources (e.g., memory, processor(s)).

The graph transformation may be performed, for example, by adding one or more hubs (with a large number of outgoing edge) to the graph. The addition of the hubs may shift the distribution of the graph towards the out-degree scale-free distribution that converges more efficiently. It is noted that hubs may be added, for example, since deleting hubs reduces convergence performance of the graph, as described herein (e.g., by shifting the graph away from the out-degree scale-free distribution).

The initial topological structure and the adapted topological structure may be statistically similar according to a graph similarity requirement. Results obtained using the adapted topological structure may satisfy the initial topological structure.

Alternatively or additionally, the graph is analyzed to identify a set of largest nodes with the largest number of edges. The initial graph state of the network may be transformed to an adapted graph state of the network having an adapted set of the largest nodes with a reduced number of the largest number of edges. The initial graph may be adapted (e.g., using graph transposition methods) to reduce the number of edges of the largest nodes of the identified set, for example, by deleting nodes and edges. Inventors discovered that probability of identifying a set of variable parameter weights that achieve the desired global value (within the tolerance requirement) is relatively low for graphs with a reduced number of hubs.

As used herein, the term fixed point(s) means a steady state in which the coordinates of the dynamical system are fixed and do not change (e.g., over time). The fixed points may be defined as remaining within the tolerance requirement, which may allow for limited dynamics of the fixed points. The term convergence may include the fixed points.

Alternatively or additionally, the number of fixed points in the dynamical system represented by the network is increased. Inventors discovered that increasing the number of fixed points improves the efficiency of convergence of the graph (e.g., in terms of reduced computation time and/or reduced processing resource requirements).

Alternatively or additionally, the graph is selected for processing according to the topological structure. Graphs including out-degree scale free distributions may be selected for processing (e.g., according to acts 106-112 of FIG. 1).

At 106, the current global value is calculated. The current global value may be calculated by a function of the variable weights of the directional edges, and/or the coordinates.

The current global value may be calculated by a combination of the coordinates in the dynamical system, for example, a linear and/or non-linear and/or other combination.

Optionally, an external approximate constraint is defined, which may be mathematically represented as: y(\vec{x}(t))≈y*.

Where:

y denotes a macroscopic phenotype (also referred to herein as a current global value).

y* denotes a desired global value according to a tolerance requirement of the desired global value.

Optionally, y is calculated as a combination of microscopic variables (also referred to herein as coordinates,), which may be mathematically represented as y(t)=\vec{b}·\vec{x}(t), where \vec{b} denotes an arbitrary vector of coefficients. The combination may be linear, and/or other combinations, for example, non-linear.

Each possible macroscopic phenotype (i.e., the desired global value within the tolerance requirement) may be realized by multiple different microscopic configurations, for example, multiple combinations of the coordinates and/or by multiple combinations of variable weight parameters.

At 108, a mismatch between the current global value (based on current value assigned to the variable weights of the directional edges of the graph) and the desired global value is calculated.

The mismatch may be calculated as a function of the different between the calculated current global value and the desired global value. Alternatively or additionally, the mismatch is calculated by a step function outside the tolerance requirement. The value of the step function may be defined as zero within the tolerance requirement.

The mismatch may be mathematically represented as: [symbol] (y−y*).

The tolerance requirement represents multiple combinations that satisfy the desired global value, for example, rather than a single or small number of values that obtain the solution. Multiple different combinations of assigned variable weights of the predefined directional edges and/or coordinates are associated with the desired global value within the tolerance requirement. As such, the mismatch may be defined to be zero by one or more combinations that fall within the tolerance requirement. In other words, there are multiple ways for the graph to converge, and only one solution which is good enough may be needed.

At 110, the amount of mismatch is evaluated. The mismatch may be defined as zero (when within the tolerance requirement) or another value (e.g., a value of 1, or other value(s)) when outside the tolerance requirement, for example, according to the step function. The amount of mismatch may be calculated when outside the tolerance requirement, which may be indicative of how far the current global value is from the suitable solution zone defined by the tolerance requirement.

The mismatch may be effectively zero when the calculated global value is within a comfort zone (e.g., of size ε) around y*. The amount of mismatch increases (optionally sharply) outside of the comfort zone. There is no mismatch and the constraint is satisfied within the region around y*, which is noted to be different than optimization problems that solve a requirement to reach an optimal solution.

The mismatch evaluation may be a binary decision, for example, either there is a mismatch or there isn't a mismatch. Alternatively, the mismatch evaluation may be performed as an adjustment, for example, using a smooth amplitude function proportional to the mismatch.

The mismatch evaluation is not necessarily based on whether the amount of mismatch is zero within the tolerance region. For example, the mismatch amount may be nonlinear. For example, the mismatch may be defined as effectively zero according to a requirement such as a range defined as effectively zero, which may be relative to the stability of the graph. For example, using the smoothing function, nonzero values may be defined as zero when falling within the range defined as effectively zero.

At 112, the mismatch is outside of the tolerance requirement (e.g., the phenotype deviates from the comfort zone, the current global value is not close enough to the desired global value according to the tolerance requirement). One or more weight parameters are randomly adjusted. Optionally, all the weight parameters (i.e., of all edges) are randomly adjusted. The adjustment is performed within the respective ranges associated with the edges and/or coordinates. Blocks 106-110 are iterated.

The variable weights of the directional edges are adjusted, optionally randomly, for example, using a random number generation code, and/or other code that applies a non-deterministic method to obtain values.

Optionally, the adjustment is performed by a function according to the present value associated with each respective weight parameter, for example, adding or subtracting (or performing other calculations) the randomly generated number (e.g., a relatively small number, for example, a percentage, or an absolute value, which may relate to the context of the graph and/or node, for example, about 0.01%, or 0.1%, or 1%, or 10%, or other values).

Optionally, each weight parameter is independently adjusted, for example, by obtaining and/or generating a random number for each weight parameter, independently of other weight parameters.

Optionally, the variable weights of the predefined directional edges are randomly adjusted within respective ranges according to a function proportional to the amount of mismatch. For example, when the current global value is far from the tolerance requirement, relatively larger random values may be used, which may help the graph converge within the tolerance requirement during the next iteration. An iterative reduction in the amount of mismatch may reduce the amount of the random adjustment within the respective range. For example, when the global current value is close to the tolerance requirement, relatively smaller random values may be used, which may help the graph converge within the tolerance requirement during the next iteration.

Alternatively, the variable weights of the predefined directional edges are randomly adjusted independently of other values, for example, using relatively small values.

It is noted that the adjustment is performed without necessarily requiring prior knowledge of the network structure and/or graph (e.g., other than the randomly generated initial set of values).

The adjustment of the variables weight parameters may be according to the amount of mismatch, for example, according to the mathematical relationship:

dJ(t)=\sqrt{D· [symbol] (y−y*)}·dξ(t),

Where:

J(t=0)=J₀

D defines the step size of the adjustment of each variable weight parameter (within respective range).

dξ(t) denotes a Gaussian white-noise matrix.

Random occurrences of a mismatch decreasing configuration in the space of connection strengths (i.e., variable weight parameters) decreases the amplitude of the search (i.e., the adjustment of the variable weight parameters), promoting relaxation.

A drive-reduction scenario may be obtained, in which the level of mismatch drives the search for variable weight parameters that arrive at the desired global value (within the tolerance requirement) and promotes convergence of the graph when a favorable configuration is reached (see for example, Y. Soen, M. Knafo and M. Elgart, “A principle of organization which facilitates broad Lamarckian-like adaptations by improvisation”. Biology Direct 10, 68 (2015) and/or G. Shahaf and S. Marom, “Learning in networks of cortical neurons.” J. Neurosc. 21, 8782-8788 (2001)).

At 114, the identified values for the variable weights of predefined directional edges and/or the coordinates are outputted when the mismatch is within the tolerance requirement. The identified values represent one arbitrary solution out of multiple ways to achieve the desired global value according to the tolerance requirement.

The determined values are outputted when at least one combination of variable weight parameters that give rise to at least one set of coordinates or for which the global value falls stably within the tolerance requirement of the desired global value.

The identified values may be provided, for example, by being presented on a display (e.g., user interface 220), stored (e.g., in data repository), used by another process, and/or transmitted to another device (e.g., to client terminal 216, to storage unit 218, to server 214, and/or over network 212).

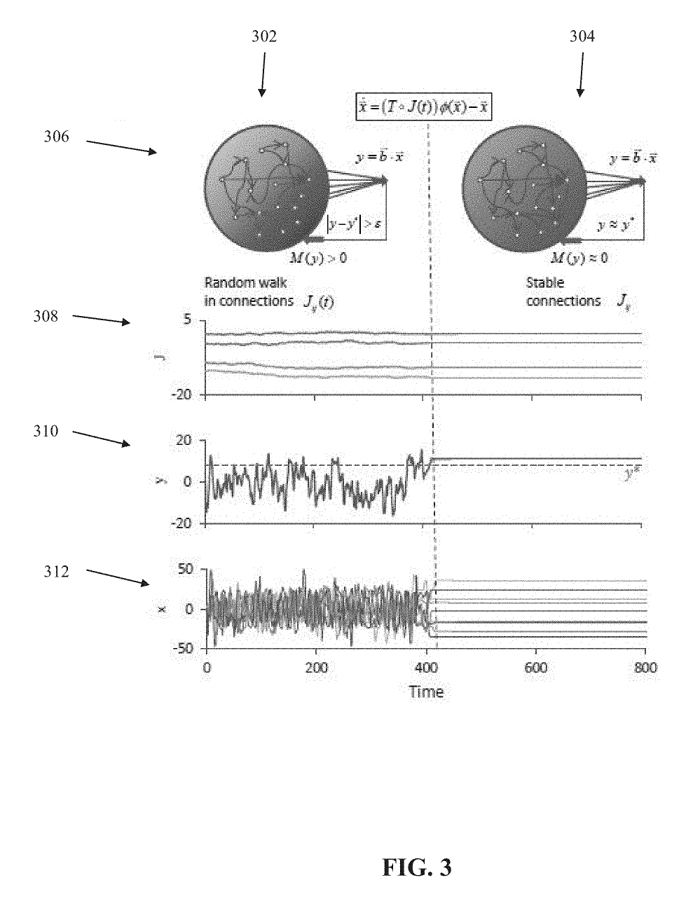

Reference is now made to FIG. 3, which includes exemplary charts to help understand the process of identifying values for variable weight parameters of edges of a network according to a desired global value within a tolerance requirement, in accordance with some embodiments of the present invention. Arrow 302 (i.e., the left side of images 306-312) depicts the process of identifying the values for the variable weight parameters (also referred to herein as the exploratory phase). Arrow 304 (i.e., the right side of images 306-312) depict the stable state of the system once the variable weight parameters that obtain the desired global value within the tolerance requirement have been identified (also referred to herein as convergence). Arrow 304 represents when the constraint y≈y* is satisfied, which occurs when t=400, during which the graph converges to within the comfort zone (i.e. within the tolerance requirement) around y* (i.e., the desired global value), for example, to a fixed point, and/or a small-amplitude limit-cycle solution within the comfort zone.

Convergence is preceded by highly irregular trajectories of \vec{x}(t) (image 312) and y(t)=\vec{b}·x{right arrow over (()}t) (image 310), which rapidly sample a large range prior to convergence. In contrast, the connection strengths (i.e., values of the variable weight parameters) remain in the vicinity of their starting point throughout the exploratory phase (image 308). This suggests that a stable solution to the arbitrarily defined adaptation problem may be found within a relatively small hypercube in the high dimensional space of interaction strengths.

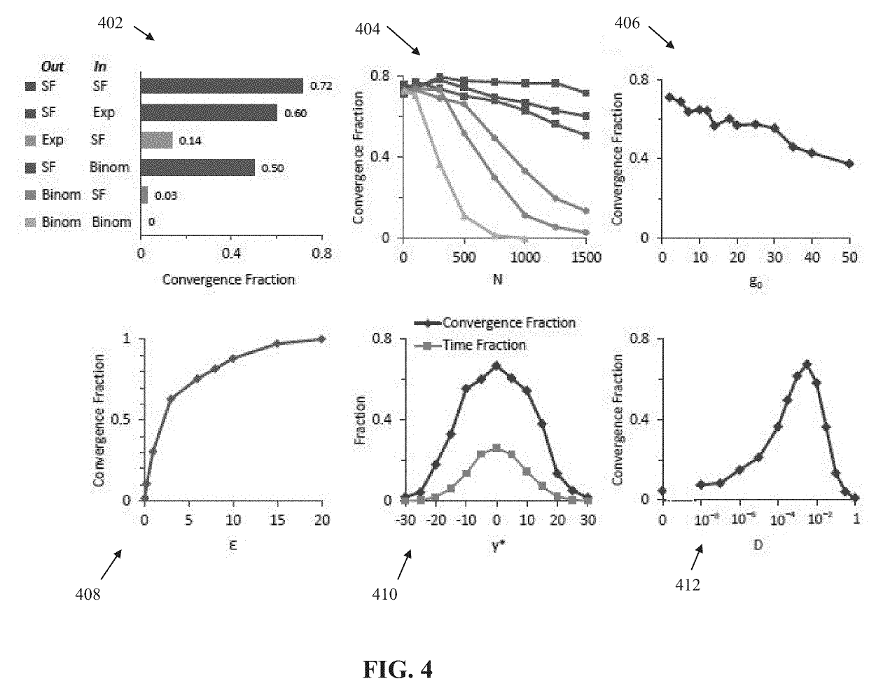

Reference is now made to FIG. 4, which includes charts 402-412 depicting factors that may (or may not) affect the speed of convergence, and/or whether convergence occurs at all (i.e., within a reasonable time), in accordance with some embodiments of the present invention. The rapid convergence in the high-dimensional space to a state which stably satisfies the constraint is not a-priori guaranteed. The convergence fraction (CF) denotes the fraction of networks that converged within a predefined fixed time window.

The data points in charts 402-412 represent the fraction of convergence within 200 time steps in an ensemble of 500 networks with random initial conditions. Ensembles in charts 402-410 (i.e., excluding chart 412) include networks with random and unique T, J₀, and \vec{x}₀. Ensembles in chart 412 include networks with random and unique J₀, and \vec{x}₀ and fixed topologies {T₁⁰ . . . T₁₀⁰}, which are obtained from a single topology T⁰ by deleting the i maximal out-going hubs. Unless otherwise mentioned, charts 402-412 are based on the values: N=1000, y*=0, g₀=10, and D=10⁻³. In charts 402-412 scale-free degree distribution is based on the parameter values α=1, and γ=2.4. Binomial degree distribution is based on the parameter values

$$( p \sim \frac{3.5}{N} , N ) .$$

Exponential degree distribution is based on the parameter value β=3.5.

Inventors discovered that convergence depends on the topological structure of the network (e.g., graph representation). The dependence is quantified by computing the fraction of simulations which converged within a given time window and comparing this fraction among ensembles with different topology.

Chart 402 displays convergence fraction for ensembles of networks of size N=1500 with in- and out-degrees drawn from Binomial (Binom), exponential (Exp) and scale-free (SF) distributions. Seven combinations of network topologies were tested using a common backbone adjacency matrix T, with Gaussian random values at nonzero entries of the backbone. Chart 402 provides computational evidence that high fractions (e.g., above 0.5) of convergence occur in networks with heterogeneous (i.e., scale-free) out-going degree distributions. For fully or sparsely connected homogenous random network, the CF is close to zero. For example, comparison of networks with SF outgoing vs. SF incoming degrees reveals a significantly larger convergence fraction in the former case. For example, the convergence fraction of networks with SF out-degree and Binomial in-degree distributions is 0.5, as opposed to 0.03 in the inverse (transposed) case. Based on the computational results, convergence fractions of about 0.5 or higher are observed in ensembles with SF outgoing connection distributions. It is noted that the ability of the systems and/or methods described herein to model asymmetry in adaptation performance is further supported by the obtained computational results described herein, that are similar to empirical observation of a broader out-degree, vs. in-degree distribution in the yeast regulatory network (see for example, N. Guelzim, S. Bottani, P. Bourgine and F. Kps, “Topological and causal structure of the yeast transcriptional regulatory network”, Nat. Genet. 31, 60 (2002)).

Chart 404 depicts CF as a function of network size for the same combination of network topologies of chart 402. An analysis of the convergence fraction as a function of network size (e.g., number of nodes in the graph, N) suggests that the effect of network topology becomes pronounced above a certain size. Convergence in small to intermediate-sized networks (N<about 200) is higher and relatively independent of the topology. However, as network size increases towards sizes that are typical of gene regulatory networks (or other large systems), graphs with scale-free out-degree topologies outperform other topologies.

Charts 406-412 depict results for the SF(out)-Binom(in) combination.

Charts 406-412 provide computational evidence that the convergence fraction depends on other model parameters, including the normalized standard deviation of interaction strength, g0, the details of the constraint and the speed of exploration. The interaction strength g (network gain, proportional to the standard deviation of the network's connection strengths) may have a strong impact on the dynamics of fully connected networks (see for example, H. Sompolinsky, A. Crisanti and H. J. Sommers, “Chaos in Random Neural Networks”, Phys. Rev. Lett. 61, 259-262 (1988)). However, it is noted that increasing the initial interaction strength g0 in the systems and/or methods described herein induced larger amplitude fluctuations in \vec{x}, but does not appear to have a strong effect on the convergence fraction (chart 408).

Chart 410 investigates how the severity of the external constraint, y(\vec{x}(t))≈y*:, affects convergence, by testing the effects of shifting y* away from zero. Chart 410 depicts the dependence of CF on the value of constraint y*. For comparison, the fraction of time the variable y encountered the required range of phenotype spontaneously over a long trajectory prior to convergence is shown. Fluctuations of the phenotype y prior to convergence define a probability to spontaneously visit the vicinity of the required value (Time Fraction curve). Due to the symmetric nature of the equation of motion the probability is distributed around zero. Shifting y* away from zero to rarely encountered values poses a stronger challenge for converged by the graph. Such shifting leads to a decrease in convergence fraction as a function of the magnitude of the shift (Convergence Fraction curve). Notably, however, the convergence fraction remains significantly larger than the probability of encountering the required phenotype spontaneously (i.e., Time Fraction). For example, a non-negligible fraction of convergence (0.2) is observed for a phenotype which is spontaneously encountered with probability of 0.02. It is noted that alternatively, the severity of the constraint may be increased by reducing the size of the comfort zone (i.e., the tolerance requirement).

Chart 412 depicts CF as a function of D, the effective diffusion coefficient for exploratory random walk in connection strengths. To evaluate the effect of exploration speed, the effective diffusion coefficient in the space of connection-strength, D, is varied. Chart 412 depicts computational results that suggest that the convergence fraction is weakly dependent on the D parameter, since convergence remains in the range 0.2-0.7 over more than 5 decades of D.

Based on the computational results, Inventors discovered that the convergence fraction in networks larger than about 1000 (i.e., N, number of nodes), depends mostly on network topology. For the network ensembles with a scale-free out degrees, the observed large fraction of convergence does not require fine tuning of other parameters.

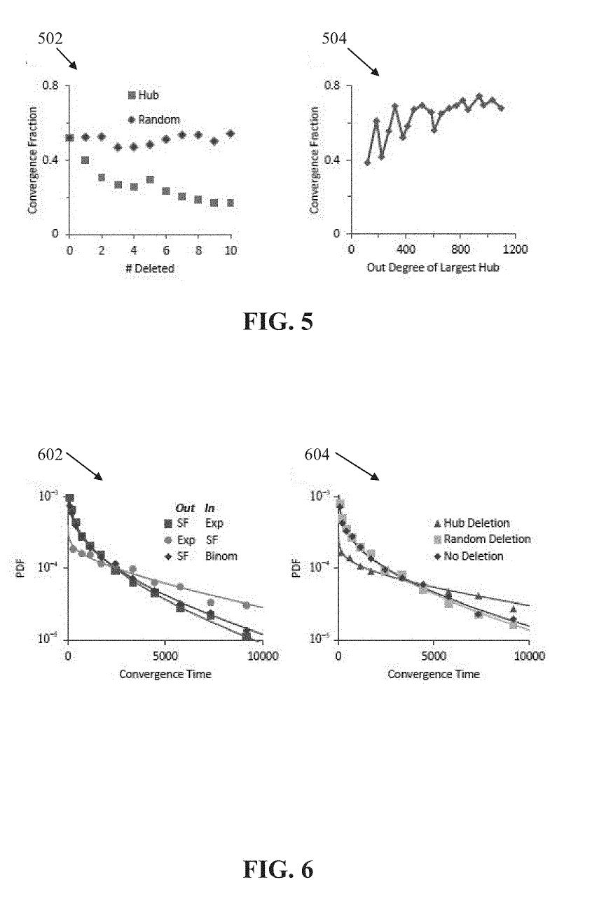

Reference is now made to FIG. 5, which includes charts 502 and 504 that evaluate the contribution of outgoing hubs (i.e., nodes) to convergence, in accordance with some embodiments of the present invention. The analysis of chart 502 is performed by comparing the influence of deleting nodes of highest out-degree to the effect of deleting random nodes. Chart 504 provides computational evidence that suggests that the ability to converge by exploratory dynamics is strongly and primarily affected by a small number of outgoing hubs. Comparison between scale-free networks with different sizes of the largest hubs further reveals positive correlation between hub size and convergence fraction.

Reference is now made to FIG. 6, which includes charts 602 and 604 providing computational results of convergence time, in accordance with some embodiments of the present invention. For networks that converged in less than 10⁴ timesteps, the probability distribution (PDF) of time to converge is plotted. All distributions show extremely slow decay (lines represent stretched exponential fits between the plotted points). Chart 602 denotes convergence time distribution for three topological ensembles. Chart 604 denotes the effect of random node deletion and deletion of 8 maximal hubs on the distribution, for the SF(out)-Binom(in) ensembles.

Ensembles in charts 602 and 604 include networks with random and unique T, J₀, and \vec{x}₀. Charts 602 and 604 are based on the values: N=1000, y*=0, g₀=10, and D=10⁻³. In charts 602 and 604 the scale-free degree distribution is based on the parameter values α=1, and γ=2.4. Binomial degree distribution is based on the parameter values

$$( p \sim \frac{3.5}{N} , N ) .$$

Exponential degree distribution is based on the parameter value β=3.5.

It is noted that FIGS. 3-5 relate to convergence within a predefined time interval. Evaluation of the distribution of convergence times in repeated simulations reveals a broad distribution (Coefficient of Variation, standard deviation (STD)/MEAN about 1.1) that is well fitted by a stretched exponential. It is noted that the computational results support use of the systems and/or methods described herein to model complex system, for example, based on similar distributions found in other complex systems (see for example, H. Kim, C. I. del Genio, K. E. Bassler and Z. Toroczkai, “Constructing and sampling directed graphs with given degree sequences”, New J. Phys. 14, 023012 (2012)), and may reflect a hierarchy of timescales. Inventors discovered that while long tailed distributions are observed in all the tested topologies, networks with scale-free out-degrees typically converge faster than networks without large heterogeneity in out-degrees, as illustrated by chart 602. Moreover, chart 604 provides computational evidence that deletion of the largest outgoing hub(s) leads to significant reduction in the frequency of fast convergence.

Based on the computations, inventors discovered that Networks with large heterogeneity in out-degrees are both more likely to converge within a set time window (e.g., as shown in FIG. 4), and typically converge within shorter timescales (e.g., as shown in FIG. 6).

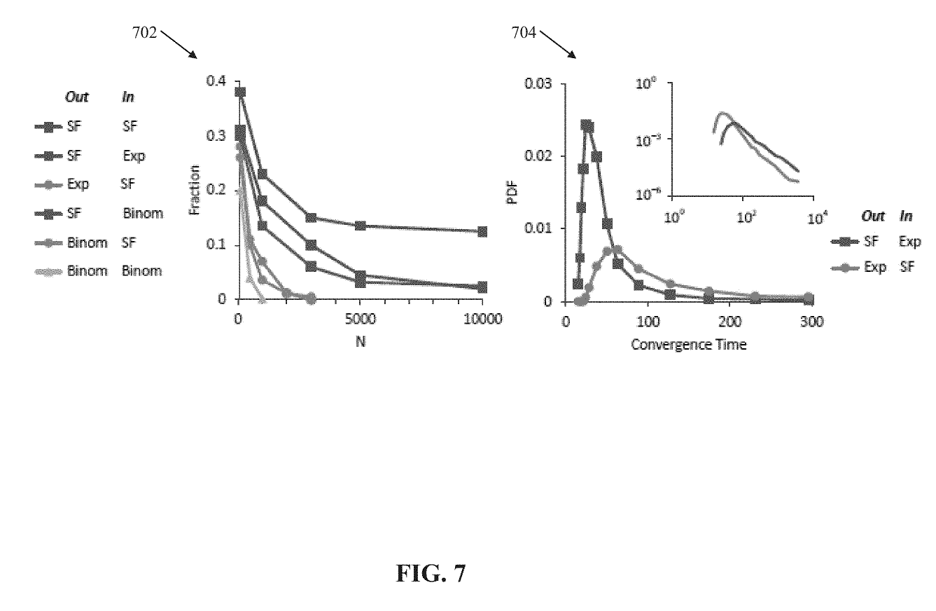

Reference is now made to FIG. 7, which includes charts 702 and 704 that depict results of computations designed to test whether network topology has an intrinsic influence on the ability to support convergent dynamics independently of constraints, in accordance with some embodiments of the present invention. Charts 702 and 704 depict properties of the open-loop nonlinear dynamics for different network topological ensembles. Chart 702 depicts the fraction of networks within an ensemble which converged (e.g., to a fixed point) using non-linear dynamics (e.g., as described herein), with a fixed interaction matrix. A comparison with chart 404 of FIG. 4 shows that ensembles which are more successful in exploratory adaption are those that converged (e.g., to fixed points) with higher probability. Chart 704 depicts distributions of time to converge for two of the ensembles plotted in chart 702. Both ensembles include a broad power-law like tail, with a typical timescale for convergence that is shorter for the SF-out ensemble (the more successfully adapting ensemble, as described herein).

Charts 702 and 704 depict results of computations designed to estimate convergence in open-loop configuration (no constraint and no random walk in connection strengths). The results of the computational simulations show that the ability of a certain network to support convergence (e.g., to a fixed point within the tolerance requirement of the desired global value) is largely insensitive to the initial conditions in x-space (not shown). Inventors computed, for each topological ensemble, the fraction of networks supporting convergence within a fixed time window, starting with random initial conditions. Chart 702 illustrates topology-dependent differences that are qualitatively in line with the closed-loop results (chart 404 of FIG. 4). In particular, convergence to fixed points with N>3000 was observed only in ensembles with scale-free out degree distributions. Based on the computations, inventors discovered that a substantial contribution to exploratory adaptation in closed-loop, is provided by high availability of networks capable of accommodating convergence in open-loop.

An analysis of the distribution of convergence times indicates that the topology of the graph influences the time to converge in open-loop. Chart 704 demonstrates the above concept by comparing convergence times for networks with SF-out/Exp-in degrees to the inverse case of Exp-out/SF-in degrees. Chart 704 indicates that networks with SF-out degrees typically support faster convergence in \vec{x}-space. Recalling that exploratory adaptation (in closed-loop) involves a random walk among networks with different connection strengths, rapid relaxation may support adaption by allowing the code to identify a convergence based on the graph to a solution before the random walk has had a chance to significantly modify the network connections.

Ensembles in charts 702 and 704 are based on the values: N=1000, g=10. The scale-free in/out distributions are based on the parameter values α=1, and γ=2.4. Binomial degree distribution is based on the parameter values

$$( p \sim \frac{3.5}{N} , N ) .$$

Exponential degree distribution is based on the parameter value β=3.5.

The computational results reported in FIGS. 3-7 are based on networks constructed using the method described with reference to H. Kim, C. I. del Genio, K. E. Bassler and Z. Toroczkai, “Constructing and sampling directed graphs with given degree sequences”, New J. Phys. 14, 023012 (2012). Scale-free random degrees sequences were sampled by discretization of the Pareto Distribution, mathematically represented as:

$$P ( k ) = \frac{( γ - 1 ) {a}^{γ - 1}}{{k}^{γ}}$$

Sampling scale-free degree sequences using the discrete Zeta distribution provides qualitatively similar results (results not shown). Exponential degree distribution were sampled by discretization of the Exponential distribution, mathematically represented as:

$$P ( k ) = \frac{1}{β} {e}^{- k / β}$$

Initial values of J are normally distributed with

$${J}_{{0}_{ij}} \sim 𝒩 ( 0 , \frac{{g}_{0}^{2}}{( k )} ) ,$$

where [symbol] k [symbol] denotes the mean in and out degree of the network and g₀ controls the initial spectral radius of W.

The desired global value (also referred to herein as the macroscopic phenotype), y, may be defined according to the relationship:

y(\vec{x})=\vec{b}·\vec{x}, where

\vec{b} denotes a weight vector characterized by a sparseness

$$\frac{1}{N} < c < 1.$$

Non-zero weights of \vec{b} are normally distributed with

$${b}_{i} \sim 𝒩 ( 0 , \frac{1}{{g}_{0}^{2} \cdot cN} \cdot α ) ,$$

where

$$\frac{1}{{g}_{0}^{2} \cdot cN}$$

denotes a normalizing factor, and α denotes a scaling parameter controlling the variance of the phenotype. The computational results represent the values of α=100, and c=0.2.

[symbol] (y) denotes a function to calculate the mismatch, defined as a symmetric sigmoid

$$ℳ ( y ) = \frac{{ℳ}_{0}}{2} ( 1 - tanh ( \frac{\vert y \vert - ε}{μ} ) )$$

where:

2ε denotes the size of the low-mismatch comfort zone (also referred to herein as the tolerance requirement) around y* (also referred to herein as the desired global value)

μ≧denotes control of the steepness of the sigmoid function,

[symbol] ₀ denotes the maximal value of the sigmoid function.

A different mismatch function which is defined as zero in the region (−ε, ε) and linear in |y| outside of the region has also been examined, and provides qualitatively similar results.

Inventors discovered that the ability to obtain convergence and/or stability is improved with a flat region with zero or very low mismatch around y*.

The computational results were obtained with assigned values: ε=3, μ=0.01, and [symbol] ₀=2.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant representations of complex systems will be developed and the scope of the terms graph and network are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method for identifying values for variable weight parameters of edges of a network according to a desired global value within a tolerance requirement, comprising:
receiving a graph representation of a network comprising a plurality of nodes with directional edges each associated with a variable weight representing an interaction strength of the respective direction edge adjustable according to a respective range;
calculating a current global value defined by a function of the variable weights of the directional edges;
calculating a mismatch between the current global value and a desired global value, wherein multiple different combinations of assigned variable weights of the directional edges are associated with the desired global value within the tolerance requirement;
determining when the mismatch is within a tolerance requirement representing a plurality of desired global values;
and one of:
randomly adjusting the variable weights of the directional edges within the respective range, and iterating the calculating the mismatch and determining when the mismatch is not within the tolerance requirement, and
outputting determined values for the variable weights of the directional edges when the mismatch is within the tolerance requirement.

2. The method of claim 1, wherein randomly adjusting comprises randomly adjusting the variable weights of the directional edges within the respective range according to a function proportional to the amount of mismatch.

3. The method of claim 1, wherein an iterative reduction in the amount of mismatch reduces the amount of the random adjustment within the respective range.

4. The method of claim 1, wherein the network represents a chemical reaction, wherein each node represents a reactant, or an intermediate product, wherein each directed edge represents a reaction condition, wherein the desired global value represents a desired product, wherein the tolerance requirement represents a tolerance of the desired product.

5. The method of claim 1, wherein the network represents a gene regulatory network, wherein each directed edge represents the effect of one gene product on another gene through various mechanisms of regulation, wherein the desired global value represents a phenotype, the mismatch from the desired global value represents a global cellular stress signal, wherein the tolerance requirement represents a range of phenotypes compatible with a constraining demand.

6. The method of claim 1, wherein an initial set of the variable weights assigned to the directional edges are randomly determined within the respective range.

7. The method of claim 1, further comprising receiving an initial topological structure of the network, and converting the initial topological structure to an adapted topological structure of the graph including at least a scale-free out-degree distribution, wherein the initial topological structure and the adapted topological structure are statistically similar according to a graph similarity requirement.

8. The method of claim 7, wherein the in-degree distribution of the adapted topological structure of the graph is a member of the group consisting of: scale-free distribution, exponential distribution, and binomial distribution.

9. The method of claim 7, wherein converting comprises performing a graph transformation.

10. The method of claim 1, further comprising analyzing the topological structure of the graph representation of the network, and applying the acts of the computer implemented method when the topological structure is identified at least as including a scale-free out-degree distribution.

11. The method of claim 1, further comprising receiving an initial graph state of the network, analyzing the graph to identify a set of largest nodes with the largest number of edges, and transforming the initial graph state of the network to an adapted graph state of the network having an adapted set of the largest nodes with a reduced number of the largest number of edges.

12. The method of claim 1, wherein the number of nodes is at least 1000.

13. The method of claim 1, wherein the current global value is calculated by a linear or non-linear combination of the variable weights of the directional edges.

14. The method of claim 1, wherein the current global value is calculated as a linear or non-linear combination of coordinates corresponding to the variable weight parameters.

15. The method of claim 1, wherein the graph represents a dynamical system represented by at least one function that describes time dependence motion of at least one point in a geometrical space.

16. The method of claim 1, wherein the mismatch is calculated by a step function outside the tolerance requirement and a value of zero within the tolerance requirement.

17. The method of claim 1, wherein the determined values are outputted when at least one combination of variable weight parameters that give rise to at least one set of coordinates or which the global value falls stably within the tolerance requirement of the desired global value.

18. A system for identifying values for variable weight parameters of edges of a network according to a desired global value within a tolerance requirement, comprising:
a program store storing code; and
a processor coupled to the program store for implementing the stored code, the code comprising:
code to receive a graph representation of a network comprising a plurality of nodes with directional edges each associated with a variable weight representing an interaction strength of the respective direction edge adjustable according to a respective range;
code to calculate a current global value defined by a function of the variable weights of the directional edges, calculate a mismatch between the current global value and a desired global value, wherein multiple different combinations of assigned variable weights of the directional edges are associated with the desired global value within the tolerance requirement, and determine when the mismatch is within a tolerance requirement representing a plurality of desired global values;
and one of:
randomly adjust the variable weights of the directional edges within the respective range, and iterating the calculating the mismatch and determining when the mismatch is not within the tolerance requirement, and output determined values for the variable weights of the directional edges when the mismatch is within the tolerance requirement.

19. A computer program product comprising a non-transitory computer readable storage medium storing program code thereon for implementation by a processor of a system for identifying values for variable weight parameters of edges of a network according to a desired global value within a tolerance requirement, comprising:
instructions to receive a graph representation of a network comprising a plurality of nodes with directional edges each associated with a variable weight representing an interaction strength of the respective direction edge adjustable according to a respective range;
instructions to calculate a current global value defined by a function of the variable weights of the directional edges;
instructions to calculate a mismatch between the current global value and a desired global value, wherein multiple different combinations of assigned variable weights of the directional edges are associated with the desired global value within the tolerance requirement;
instructions to determine when the mismatch is within a tolerance requirement representing a plurality of desired global values; and
instructions to perform one of:
randomly adjust the variable weights of the directional edges within the respective range, and iterating the calculating the mismatch and determining when the mismatch is not within the tolerance requirement, and
output determined values for the variable weights of the directional edges when the mismatch is within the tolerance requirement.
